(19) United States
(12) Patent Application Publication
(10) Pub. No.: US 2009/0250442 A1
(43) Pub. Date: Oct. 8, 2009

(54) JOINING OF DIFFICULT-TO-WELD MATERIALS

(75) Inventors: Matthew Cavalli, East Grand Forks, MN (US); Dustin P. McNally, Grand Forks, ND (US); John Hurley, Grand Forks, ND (US); Norman Bornstein, Simsbury, CT (US)

Correspondence Address: GIFFORD, KRASS, SPRINKLE,ANDERSON & CITKOWSKI, P.C, PO BOX 7021, TROY, MI, 48007-7021, US

(73) Assignee: EERC Foundation, Grand Forks, ND (US)

(21) Appl. No.: 12/327,385

(22) Filed: Dec. 3, 2008

Related U.S. Application Data
(60) Provisional application No. 60/991,966, filed on Dec. 3, 2007.

(51) Int. Cl. B23K 11/00

(52) U.S. Cl. 219/117.1

(57) ABSTRACT

The present invention discloses a process for joining materials. The process can include providing a first component with a first joint face and a second component with a second joint face. The first component, second component, and bonding layer can be assembled such that the first joint face is oppositely disposed from the second joint face with the bonding layer located at least partially therebetween. Heat can be applied to the first joint face and the second joint face with the bonding layer therebetween. In this manner, wetting and possibly slight dissolving of the first joint face and the second joint face can be afforded, with at least part of the bonding layer being vaporized. In addition, the first joint face can come into intimate contact with the second joint face and form a bond interface, with the first component being bonded to the second component across the bond interface.

### CROSS-REFERENCE TO RELATED APPLICATIONS

This application claims the benefit under 35 U.S.C. § 119(e) of U.S. Provisional Patent Application No. 60/991,966 entitled “Joining of Difficult-to-Weld Materials,” filed Dec. 3, 2007, the disclosure of which is hereby incorporated herein by reference.

### STATEMENT REGARDING GOVERNMENT INTERESTS

This invention was made with Government support under Cooperative Agreement Nos. DE-FC26-98FT40320 and DE-FC26-05NT42465 awarded by the United States Department of Energy. In addition, this invention was made with Government support under Subcontract No. 4000028064. The Government has certain rights in the invention.

### FIELD OF THE INVENTION

The present invention relates to a process for joining materials and, in particular, to a process for joining difficult-to-weld materials.

### BACKGROUND OF THE INVENTION

The manufacture of electrical power plants, petrochemical refineries, and other industrial facilities requires joining of various components. Joining of such components can be performed using welding, adhesives, threaded joints, flanges that can be bolted together, and the like. In many instances, the welding of components provides a sound engineering and economical method for joining said components, and in fact, the ability of a material to be welded can have a large impact on the material's commercial viability.

With demands for increasing the efficiency of electrical power plants, gas turbine engines and the like, the need for the use of materials that can withstand ever-increasing high temperatures continues. For example, dispersion-strengthened alloys are known to exhibit excellent high-temperature properties and have shown potential for use in many high-temperature applications. Likewise, nickel-based alloys strengthened by internal precipitants, such as gamma prime, are currently used in the hot sections of gas turbines. However, alloys such as these can present problems with respect to traditional fusion welding techniques since the melting of the base material results in the destruction of the microstructure which provides the excellent high-temperature properties.

Heretofore, joining techniques for such alloys have included diffusion bonding, friction welding, and other solid state welding processes. Diffusion bonding is a process wherein two nominally flat interfaces are joined at an elevated temperature using an applied pressure upon the interfaces to be joined. The diffusion bonding process affords the joining of dissimilar materials and/or similar materials wherein the melting of the base material has detrimental effects. However, the presence of oxide layers at the joining surfaces can affect the quality of the joint and thereby make sound, reproducible joints difficult to obtain.

A modified form of diffusion bonding is known as transient liquid phase (TLP) diffusion bonding wherein liquid-state diffusion bonding relies on the formation of a liquid phase provided by a bonding film that is inserted between the interfaces to be joined during an isothermal bonding cycle. The liquid phase subsequently diffuses into the base material and eventually solidifies as a consequence of continued diffusion into the bulk material at the isothermal temperature. The liquid phase enhances dissolution and/or disruption of any oxide layer that may be present on the interfaces to be joined and, thereby, promotes intimate contact between said interfaces. As such, the presence of the bonding film and thus the liquid phase reduces pressure and time that may be required for diffusion bonding. However, methods to TLP diffusion bond dispersion-strengthened high-temperature alloys and gamma prime nickel-based alloys have met with limited success. Therefore, a process for bonding of such alloys and/or a bond foil having a composition that affords for improved bond joints would be desirable. In addition, a clamping device that affords the application of applied stress to the components to be joined would be desirable.

### SUMMARY OF THE INVENTION

The present invention discloses a process for joining materials. The process can include providing a first component with a first joint face and a second component with a second joint face. The first joint face and the second joint face can be prepared for bonding, and a bonding layer can be provided. The first component, second component, and bonding layer can be assembled such that the first joint face is oppositely disposed from the second joint face with the bonding layer located at least partially therebetween. In addition, a force can be applied to the assembly of the first component, second component, and bonding layer such that the first joint face is compressed against the second joint face with the bonding layer therebetween. In some instances, the bonding layer can be a bonding foil, and the bonding foil may or may not be a zinc foil.

A thermal treatment can be applied to the first joint face and the second joint face with the bonding layer therebetween, thereby affording for at least part of the bonding layer material to melt, the first joint face coming into intimate contact with the second joint face and forming a bond interface, and the first component being bonded to the second component across the bond interface, with at least part of the bonding layer vaporizing during the process. In addition, an atmosphere surrounding the first joint face and the second joint face with the bonding layer therebetween can be controlled before, during, and/or after the thermal treatment. In some instances, the thermal treatment can be a multiple step thermal treatment to the first joint face and the second joint face with the bonding layer therebetween.

### BRIEF DESCRIPTION OF THE DRAWINGS

FIG. 1 is a schematic diagram illustrating a process according to an embodiment of the present invention; and

FIG. 2 is a side view of a clamping device that can be used with an embodiment of the present invention.

### DETAILED DESCRIPTION OF THE PRESENT INVENTION

The present invention discloses a process for joining materials using diffusion bonding, transient liquid phase (TLP) diffusion bonding, and modifications thereof. As such, the process has utility as a process for joining materials, and in particular, for joining difficult-to-weld materials.

The process includes providing components to be joined, for example, a first component having a first joint face and a second component having a second joint face. The first joint face and/or the second joint face can be prepared for bonding to each other. In some instances, the first joint face and/or the second joint face is machined. Optionally, the first joint face and/or the second joint face can be polished in addition to, or in place of, the machining.

A bonding layer can be provided. In some instances, the bonding layer is a bonding foil. The bonding foil can be a metallic foil such as a zinc foil, the term “zinc foil” for the purposes of the present invention including foil made from high-purity zinc, commercial pure zinc, zinc alloys, and the like. For example, the zinc foil can be made from zinc alloyed with aluminum, copper, lead, magnesium, nickel, iron, and/or tin. It is appreciated that the bonding layer can be a paste that is applied to the first joint face and/or second joint face or a coating that has been applied to one of the joint faces. The coating can be applied by any method known to those skilled in the art, illustratively including sputtering, chemical vapor deposition, physical vapor deposition, and the like.

The first component, second component, and bonding layer can be assembled such that the first joint face is oppositely disposed from the second joint face and at least part of the bonding layer is located therebetween. A force can be applied to the assembly of the first component and the second component with the bonding layer therebetween and afford for the first joint face to be compressed against the second joint face and the bonding layer.

The first joint face and the second joint face with the bonding layer located therebetween can be subjected to a thermal treatment, the thermal treatment affording for at least part of the bonding layer material to melt and the first joint face bonding to the second joint face, with at least part of the bonding layer vaporizing. In some instances, the thermal treatment can be a multiple-step thermal treatment, or in the alternative, a single-step thermal treatment where the temperature of the joint region is continuously increased to a final temperature. In the instance of a multiple-step thermal treatment, the thermal treatment can include a first step that includes heating the first joint face and the second joint face with the bonding layer therebetween to a first temperature, followed by holding at the first temperature for a predetermined amount of time, and a second step that includes heating to a second higher temperature followed by holding at the second temperature for a predetermined amount of time.

The first temperature may or may not be higher than the melting point or solidus temperature of the bonding layer, and the second temperature may or may not be higher than a recrystallization temperature of the first component and/or the second component. In this manner, the first temperature may result in the melting of the bonding layer, and the second temperature may result in grain growth across a bond interface between the first and second components. It is appreciated that melting of the bonding layer can afford for wetting of the first and/or second joint face and/or disrupting of any surface oxide on the first joint face, second joint face, and/or bonding layer.

It is appreciated that grain growth across the bond interface can result in improved bond joint quality and strength. It is further appreciated that cold-working of the first and/or second component proximate the first joint face and/or second joint face, respectively, can enhance grain growth across the bond interface. In the alternative, the bonding of components having different compositions can afford for one or more concentration gradients across the bond interface, the concentration gradient(s) enhancing grain growth across the bond interface and cold-working of the first and/or second component not being required.

In some instances, an atmosphere surrounding the first joint face and the second joint face with the bonding layer therebetween can be controlled. The atmosphere can be controlled by purging with an inert gas and/or by pulling or drawing a vacuum on a chamber in which the first joint face and the second joint face with the bonding layer therebetween is contained within. The inert gas can include a reducing gas such as hydrogen, for example argon with 5 volume percent hydrogen. It is appreciated that terms such as “draw,” “drawing,” “pull,” “pulled” and “pulling” are terms of art when used in the context of a vacuum and refer to the removal of atoms and/or molecules from an enclosed container, i.e. a chamber, and the establishment of a pressure that is less than atmospheric pressure therewithin.

Control of the atmosphere surrounding the first joint face and the second joint face with the bonding layer therebetween can be combined with the multiple-step thermal treatment. For example and for illustrative purposes only, a chamber containing the first joint face and the second joint face with the bonding layer therebetween can be purged with an inert gas before and/or during the first step, followed by establishing a vacuum before and/or during the second step.

During at least part of the thermal treatment, with or without the atmosphere control, contact between the interfaces to be bonded is sufficient such that diffusion takes place therebetween, and a sound metallurgical bond is provided. As stated above, the thermal treatment can include a step that affords grain growth across the bond interface, the bond interface being defined herein as an interface between two components to be joined, across which diffusion occurs to form a bonded joint. In this manner, a process wherein joints having acceptable room-temperature and/or high-temperature properties is provided.

Components that can be joined using the process disclosed herein range from typical metals and alloys used for fabricating structures to difficult-to-weld metals and alloys. For example and for illustrative purposes only, materials such as the commercial alloys MA956, PM2000, CM247LC, APMT, and the like can be joined to themselves and/or to other materials. It is appreciated that the MA956 alloy is an oxide dispersion-strengthened (ODS) alloy having a nominal chemical compositions of Fe-20Cr-4.5Al-0.5Ti-0.5Y₂O₃ (wt %); the PM2000 alloy is also an ODS alloy having a nominal chemical compositions of Fe-20Cr-5.5Al-0.5Ti-0.5Y₂O₃ (wt %); the CM247LC alloy is a gamma prime-strengthened alloy having a nominal composition of Ni-8.1Cr-9.2Co-0.5Mo-9.5W-3.2Ta-0.7Ti-5.6Al-0.01Zr-0.01B-0.07C-1.4Hf (wt %); and the APMT alloy is a powder metallurgy alloy having a nominal composition of Fe-21Cr-3Mo-5Al (wt %). It is further appreciated that these alloys, and other alloys joined by the process disclosed herein, can have other incidental impurities and additional alloying elements.

The process can also include the use of a fixture device for holding the components to be joined in an appropriate orientation with a desired stress applied thereon.

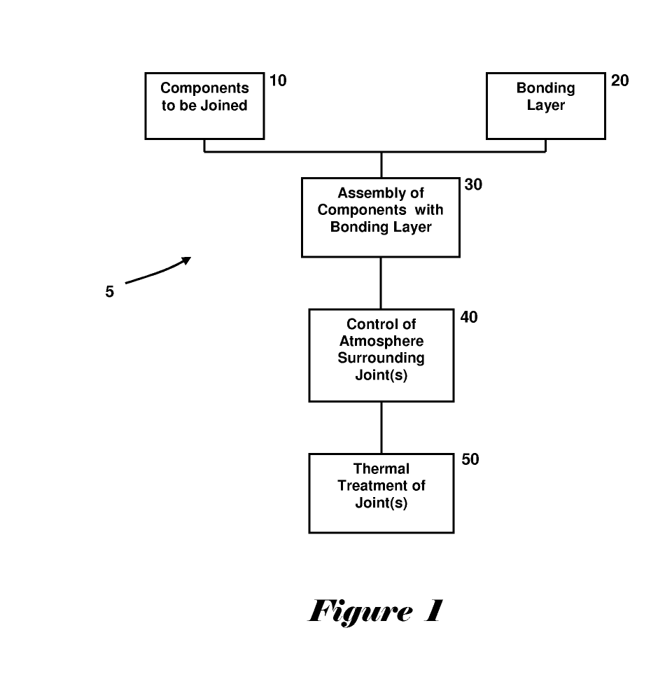

Turning now to FIG. 1, a process for joining difficult-to-weld materials is illustrated generally at reference numeral 5. The process 5 includes providing components to be joined at step 10, wherein the components can be made from any alloy or combination of alloys, metals, etc., illustratively including oxide or other ceramic dispersion-strengthened alloys, directionally solidified alloys, internal precipitate-strengthened alloys, solid solution-strengthened alloys, castings, and the like.

Included in the process 5 is a bonding layer at step 20. The bonding layer can be a zinc foil or, in the alternative, made from a material not containing zinc so long as the material has a tendency to vaporize during thermal treatment of a joint region as taught below. For example, zinc has a vapor pressure of 0.13 kilopascal (kPa) (1 torr) at 487° C., 101.3 kPa (760 torr) at 907° C. and 10,132 kPa (7600 torr) at 1180° C. In addition, zinc has a melting point of 420° C., which is less than, or about the same as, other iron-zinc or nickel-zinc alloy or intermetallic melting temperatures. As such, a zinc foil will melt before or at the same temperature as other possible zinc-containing compounds in an iron-based or nickel-based component, and vaporization of at least part of the zinc foil will reduce or eliminate the diffusion of zinc into the adjacent components.

It is appreciated that other low boiling point elements can be used for the bonding layer. For example and for illustrative purposes only, foils can be made primarily from elements such as arsenic (T_{b}=610° C.), cadmium (T_{b}=765° C., cesium (T_{b}=690° C.), magnesium (T_{b}=1110° C.), mercury (T_{b}=357° C.), phosphorus (T_{b}=283° C.), polonium (T_{b}=960° C.), potassium (T_{b}=770° C.), rubidium (T_{b}=700° C.), selenium (T_{b}=685° C.), sodium (T_{b}=890° C.), sulfur (T_{b}=445° C.), and/or tellurium (T_{b}=962° C.) where T_{b} is the boiling point of the given element at atmospheric pressure. It is appreciated that some of these materials are considered poisonous, fire hazardous and/or radioactive, and thus may limit their use as a bonding layer, but have in common with zinc a relatively low vaporization temperature.

After the components and the bonding layer have been provided, the components and said bonding layer are assembled at step 30. It is appreciated that the components to be joined can have joint faces that have been properly prepared, for example, by machining and/or polishing, and the bonding layer can be dimensioned to fit between the joint faces. The bonding layer can have a thickness between 1 micron and 1 millimeter, inclusive. In some instances, the bonding layer has a thickness between 5 microns and 200 microns and in other instances can be between 20 microns and 50 microns. Assembly of the components with the bonding layer at step 30 includes bringing the joint faces to be bonded into intimate contact with the bonding layer, the joint faces being oppositely disposed from each other with the bonding layer therebetween. In addition, pressure or an applied stress can be applied to the components such that the interfaces to be bonded and the bonding layer are under compression.

The pressure can assist in the breaking up or disruption of any oxide scale that is present on the first joint face, second joint face, and/or bonding layer. It is appreciated that the pressure can be applied with a fully articulated press or assembly device that affords for the first joint face and the second joint face to be easily aligned with each other and thus provide for intimate contact therebetween once the bonding layer has melted and diffused into the components and/or been vaporized away from the joint region.

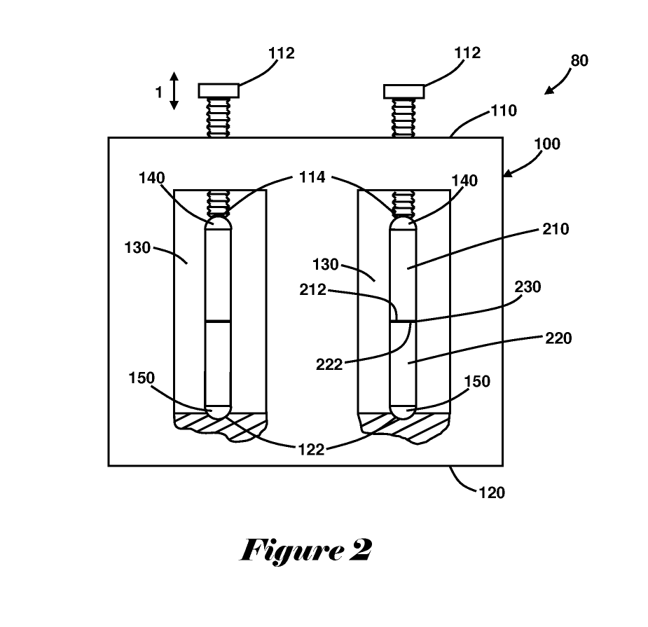

An assembly device shown generally at reference numeral 80 in FIG. 2 can be included to assist in the assembly of the components to be joined. As shown in FIG. 2, the assembly device 80 can include a body 100 having a top portion 110 and a bottom portion 120. Within the body 100 can also be at least one cavity 130 that affords for the placement of a first component 210 to be joined to a second component 220. A bonding foil 230, for example, a zinc foil, can be placed between the first component 210 and the second component 220 as illustrated in the figure. The first component 210 can have a first joint face 212 and the second component 220 can have a second joint face 222. As stated above, the first joint face 212 and/or the second joint face 222 can be prepared for bonding to the oppositely disposed joint face.

Proximate to the top portion 110 is a pressure application member 112. In some instances, the pressure application member 112 can be a threaded bolt, screw, and the like. The pressure application member 112 can have a pressure end 114 that can be moved in a back and forth direction 1. In addition to the body 100 and the pressure application member 112, a hemispherically shaped cap 140 can be placed between the pressure end 114 of the pressure application member 112 and the first component 210 to be joined. Likewise, a second hemispherical cap 150 can be placed between the member 100 and the second component 220 to be joined. It is appreciated from FIG. 2 that the cap 140 and the cap 150 are placed at distal ends or locations from first joint face 212 and second joint face 222, respectively. It is also appreciated that the pressure end 114 of the pressure application device 112 has a shape that is complementary with the hemispherical cap 140 as illustrated in FIG. 2. The body 100 can also have a machined region 122 that is complementary to the spherical portion of the hemispherical cap 150.

The hemispherical caps 140 and 150 can be made from any material known to those skilled in the art, illustratively including high-temperature alloys, alumina, silica, and the like. In some instances, the hemispherical cap 140 and 150 has a hemisphere diameter that is generally equivalent to the diameter of a rod, tube, and the like that is to be joined; however, this is not required. If the components to be joined have a cross-sectional polygon shape such as a square, rectangle, and the like, the cap 140 and cap 150 can be manufactured such that one end is complementary to the pressure end 114 and/or machined region 122 and the other end is complementary to the components to be joined.

The arcuate surface of the hemispherical cap 140 and/or 150 affords for the components to fully articulate, or move, independently from the body 100 and the pressure applied by the pressure application device 112. This articulation or movement can be critical since the joint diffusion zone that results in the bond can be relatively thin and the interfaces to be joined are preferably in intimate contact along the complete surfaces of the joint. Without the articulation, the joints can become cocked, misaligned, etc., with force on one portion being greater than another portion and the interfaces to be joined not being parallel with each other.

It is appreciated that the member 100 and the pressure application device 112 can be made from any material known to those skilled in the art for use at generally high temperatures, such as molybdenum, niobium, other metals having high-temperature strength, high-temperature nickel-based alloys, high-temperature iron-based alloys, high-temperature cobalt-based alloys, ceramics, metal matrix composites, and the like.

Returning to FIG. 1, after the components to be joined have been assembled at step 30, the atmosphere surrounding the first joint face 212 and the second joint face 222 with the bonding foil 230 therebetween, i.e., the joint region, can be controlled at step 40. In some instances, the assembly of the components to be joined is placed within an enclosed chamber such that the chamber can be evacuated and/or purged with an inert gas. In other instances, the region wherein the joint is to occur is enclosed without the entire assembly being placed in a chamber. The control of the atmosphere surrounding the joint region can be critical and, in some instances, is provided by a high vacuum. The atmosphere can also be controlled by purging the joint region with an inert and/or reducing gas, or inert gas mixture, illustratively including argon, nitrogen, mixtures of those gases with hydrogen, and the like. It is appreciated that the atmosphere can be controlled by a combination of vacuum and gas purging. A vacuum of less than 10⁻⁴ kPa (10⁻³ millibar) can assist in the vaporization of the bonding foil material away from the joint region and/or aid in decomposing of any oxide scale that is present.

An oxygen getter can be placed proximate to the joint region and/or within an enclosed chamber that contains the joint region such that excess oxygen within the atmosphere is reduced. Any oxygen getter known to those skilled in the art can be used, illustratively including an oxygen getter made from zirconium, aluminum, tantalum, titanium, and the like. In some instances, the oxygen getter is in the form of a sponge or some other high-surface-area structure. In addition, the joint region can be wrapped with oxygen getter foils such as aluminum, zirconium, tantalum, titanium, and the like.

A thermal treatment of the joint region can be provided at step 50. The thermal treatment can result in the heating of the joint region, and the heating can be provided by thermal resistance, thermal resistance furnaces, induction heating, radiant heating, and the like. The thermal treatment can include a series of time-temperature steps, such as a ramp up to a first temperature, holding the first temperature for a predetermined amount of time, ramp up or down to a second temperature, holding at the second temperature for a predetermined amount of time, ramp up or down to a third temperature, holding at the third temperature at a predetermined amount of time, and so on.

For example and for illustrative purposes only, a first component 210 made from the CM247LC alloy can be joined to a second component 220 made from the APMT alloy using a zinc foil. A chamber surrounding the first joint face 212 and the second joint face 222 with the zinc foil 230 therebetween can be purged with an argon+5% hydrogen gas and held at a pressure of between 10 to 304 kPa (0.1 to 3 atmospheres) while the joint is heated to 700° C. and held for 1 hour. This initial step can result in the melting of the zinc foil and disruption or dissolving of oxide surfaces at the first joint face 212 and/or second joint face 222. Thereafter, a high vacuum, for example a vacuum of 10⁻⁷ kPa (10⁻⁶ millibar), can be pulled around the joint region and the temperature increased to 1214° C. and held for 24 hours. During this second thermal step, grain growth and interdiffusion across the joint interface can be promoted and at least part of the zinc from the zinc foil vaporized.

It is appreciated that the second thermal processing step can include holding the joint region at the second temperature for a shorter amount of time, for example, 1 hour and thereafter reducing the vacuum and providing an Ar+5% H₂ gas. Such an alternative thermal treatment can reduce vaporization losses from assembly devices, furnace tubes, clamps, joint rods, and the like. It is appreciated that with any of these thermal treatment steps, the atmosphere can be further controlled by the introduction of oxygen getter materials therein.

Additional thermal treatment steps can be included, such as additional heating steps and subsequent cooling steps. Heat treatment, stress relief, and/or aging thermal treatment steps can be included along with the joining steps and still fall within the scope of the invention.

In this manner, a first component can be joined to a second component using a bonding layer that melts at a temperature that is lower than the melting temperature of the first component and the second component. In addition, at least part of the melted bond layer can vaporize after it wets and dissolves at least a portion of a first joint face and/or a second joint face.

The foregoing drawings, discussion, and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

We claim:

1. A process for joining materials, the process comprising:
providing a first component with a first joint face and a second component with a second joint face;
preparing the first joint face and the second joint face for bonding;
providing a bonding layer;
assembling the first component, the second component, and the bonding layer, the first joint face being oppositely disposed the second joint face and the bonding layer located at least partially between the first joint face and the second joint face, the first joint face and the second joint face with the bonding layer therebetween forming a joint region;
applying a force onto the assembly of the first component, second component and bonding layer, the first joint face being compressed against the second joint face in a manner to allow articulation of the first and second components and intimate contact of the first and second joint faces with the bonding layer therebetween;
controlling an atmosphere surrounding the joint region;
applying heat to the joint region for a predetermined amount of time, whereby at least part of the bonding layer vaporizes away from the joint region, the first joint face comes into intimate contact with the second joint face and forms a bond interface, and a bond is formed between the first component and the second component across the bond interface.

2. The process of claim 1, wherein the first component is made from a material selected from the group consisting of a dispersion-strengthened alloy, a directionally solidified alloy, a powder metallurgy alloy, and an internal precipitate-strengthened alloy.

3. The process of claim 1, wherein preparing the first joint face and the second joint face for bonding includes machining the first joint face and the second joint face.

4. The process of claim 3, wherein preparing the first joint face and the second joint face for bonding includes finishing of the first joint and the second joint face, the finishing selected from the group consisting of polishing, superfinishing, and cleaning.

5. The process of claim 1, wherein the bonding layer melts at a temperature that is lower than the melting temperature of the first component and the second component.

6. The process of claim 5, wherein at least part of the melted bond layer vaporizes after the melted bond layer wets and dissolves at least a portion of the first joint face and/or the second joint face.

7. The process of claim 5 wherein the bonding layer has a boiling temperature below 1200° C.

8. The process of claim 7 wherein the bonding layer is selected from the group consisting of zinc, arsenic, cadmium, cesium, magnesium, mercury, phosphorus, polonium, potassium, rubidium, selenium, sodium, sulfur, tellurium and alloys thereof.

9. The process of claim 1, wherein applying heat to the joint region includes a multiple-step thermal treatment.

10. The process of claim 9, wherein the, at least, two-step thermal treatment includes heating to a first-step temperature for a first predetermined amount of time and heating to a second-step temperature for a second predetermined amount of time, the second-step temperature being greater than the first-step temperature.

11. The process of claim 10, wherein the first-step temperature is between 400° and 800° C.

12. The process of claim 10, wherein the first-step temperature is between 650° and 750° C.

13. The process of claim 12, wherein controlling the atmosphere includes providing an inert gas surrounding the joint region at a pressure between 19 and 300 kilopascals.

14. The process of claim 10, wherein the second-step temperature is between 900° and 1400° C.

15. The process of claim 10, wherein the second step temperature is between 1100° and 1300° C.

16. The process of claim 15, wherein controlling the atmosphere includes pulling a vacuum surrounding the joint region at a vacuum of less than 10⁻⁴ kilopascals.

17. The process of claim 1, wherein the applying the heat to the joint region includes a single-step thermal treatment of generally increasing a temperature of the joint region to a final temperature.

18. The process of claim 1, wherein generally all of the bonding layer material vaporizes and is not present within the first component and the second component.

19. The process of claim 1, wherein the bonding layer is a bonding foil.

20. The process of claim 16, wherein the bonding foil is a zinc-based bonding foil.
